(19) United States
(12) Patent Application Publication
(10) Pub. No.: US 2014/0306977 A1
(43) Pub. Date: Oct. 16, 2014

(54) IMAGE PROCESSING APPARATUS, IMAGE PROCESSING METHOD, IMAGE PROCESSING SYSTEM, AND COMPUTER READABLE STORAGE MEDIUM

(71) Applicant: KABUSHIKI KAISHA TOSHIBA, Tokyo (JP)

(72) Inventors: Mika Minematsu, Tokyo (JP); Masataka Goto, Kanagawa (JP); Hiroyuki Aizu, Kanagawa (JP)

(73) Assignee: KABUSHIKI KAISHA TOSHIBA, Tokyo (JP)

(21) Appl. No.: 14/179,732

(22) Filed: Feb. 13, 2014

(30) Foreign Application Priority Data
Apr. 12, 2013 (JP) 2013-084383

(51) Int. Cl. G09G 5/393

(52) U.S. Cl. CPC G09G 5/393
USPC 345/545

(57) ABSTRACT

An image processing apparatus includes an image drawing region determining module, a virtual buffer allocation module, a physical buffer allocation module, a first converter, and an image drawing module. The image drawing region determining module determines an image drawing region based on first image information. The virtual buffer allocation module allocates virtual addresses to a virtual buffer configured to store the first image information virtually. The physical buffer allocation module allocates physical addresses to a physical buffer configured to store second image information corresponding to the determined image drawing region. The first converter converts at least a part of the allocated virtual addresses into at least a part of the allocated physical addresses. The at least part of the virtual addresses corresponds to the second image information. The image drawing module stores he second image information in the physical buffer based on the physical addresses obtained through the conversion.

### CROSS-REFERENCE TO RELATED APPLICATION(S)

The present disclosure claims priority to Japanese Patent Application No. 2013-084383, filed on Apr. 12, 2013, which is incorporated herein by reference in its entirety.

### FIELD

Embodiments described herein relate generally to an image processing apparatus, an image processing method, an image processing system, and a computer readable storage medium.

### RELATED ART

There may be a case where image information of only a portion of a desktop screen is required.

### BRIEF DESCRIPTION OF THE DRAWINGS

FIG. 1 shows a configuration example of an image processing apparatus according to a first embodiment;

FIG. 2 illustrates a procedure of address conversion from a virtual address of a virtual buffer into a physical address of a physical buffer according to the first embodiment;

FIG. 3 shows an example application screen according to the first embodiment;

FIG. 4 shows an example of how to draw an image in a physical buffer according to the first embodiment;

FIG. 5 is a flowchart showing an outline of a buffer allocation process according to the first embodiment;

FIG. 6 is a flowchart showing an outline of image processing according to the first embodiment;

FIG. 7 shows a configuration example of an image processing apparatus according to a second embodiment;

FIG. 8 shows an example of a application screen according to the second embodiment;

FIG. 9 shows an example of how to draw an image in a physical buffer according to the second embodiment;

FIG. 10 shows an example of how to draw an image in a physical address space according to the second embodiment;

FIG. 11 is a flowchart showing an outline of a buffer allocation process according to the second embodiment;

FIG. 12 is a flowchart showing an outline of image processing according to the second embodiment;

FIG. 13 shows a configuration example of an image processing apparatus according to a third embodiment;

FIG. 14 is a flowchart showing an outline of image processing according to the third embodiment; and

FIG. 15 illustrates an example of a moving image transmission process according to the third embodiment.

### DETAILED DESCRIPTION

Various embodiments will be described hereinafter with reference to the accompanying drawings.

According to one embodiment, an image processing apparatus includes an image drawing region determining module, a virtual buffer allocation module, a physical buffer allocation module, a first converter, and an image drawing module. The image drawing region determining module is configured to determine an image drawing region based on first image information. The virtual buffer allocation module is configured to allocate virtual addresses to a virtual buffer configured to store the first image information virtually. The physical buffer allocation module is configured to allocate physical addresses to a physical buffer configured to store second image information corresponding to the image drawing region determined by the image drawing region determining module. The first converter is configured to convert at least a part of the virtual addresses allocated to the virtual buffer into at least a part of the physical addresses allocated to the physical buffer. The at least part of the virtual addresses corresponds to the second image information. The image drawing module is configured to store the second image information in the physical buffer based on the physical addresses obtained through the conversion by the first converter.

### First Embodiment

This embodiment is directed to a case where image information for a determined image drawing region is stored in physical memory and other information is stored in a dummy page.

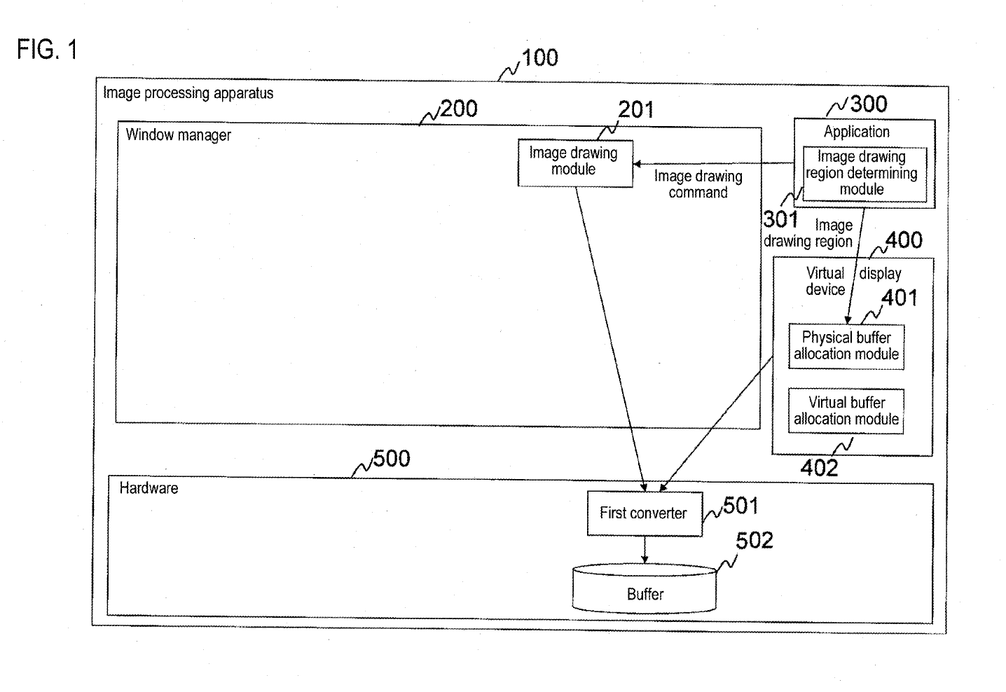

FIG. 1 shows a configuration example of an image processing apparatus 100 according to the first embodiment. As shown in FIG. 1, the image processing apparatus 100 includes an application 300, a virtual display device 400, a window manager 200, and hardware 500.

The application 300 may be a program that provides various kinds of processes and runs on the image processing apparatus 100. The application 300 includes an image drawing region determining module 301.

The image drawing region determining module 301 determines a region in which the image processing apparatus 100 should draw an image. The image drawing region determining module 301 may employ any image region determining method. One method is to employ, as an image drawing region, a region specified by a user. Another method is to employ, as an image drawing region, a region for which image drawing commands are given at a higher frequency than a certain threshold value. In the case of browser applications, a particular condition may be set for each type of application (for example, a region corresponding to a canvas element is employed as an image drawing region).

The virtual display device 400 includes a virtual buffer allocation module 402 and a physical buffer allocation module 401.

The virtual buffer allocation module 402 virtually allocates a buffer that stores image information to be generated by the image processing apparatus 100, and allocates virtual addresses having a size corresponding to the thus-allocated virtual buffer to the virtual buffer. The virtual buffer is allocated according to a resolution setting of a client-side display. For example, where the client-side display has an XGA resolution (1,024×768 pixels), a virtual buffer having a size of 1,024×768 pixels is allocated. A virtual buffer having a size specified by the application 300 rather than a size corresponding to the resolution of the client-side display may be allocated.

The physical buffer allocation module 401 physically allocates a buffer (physical buffer) 502 for storing image information to be generated by the image processing apparatus 100. The buffer 502 is allocated according to the image drawing region. For example, where the image drawing region has a size of 1,024×4 pixels, a physical buffer having a size of 1,024×4 pixels is allocated. The physical buffer may be implemented by any of commonly used storage media such as a RAM (random access memory), an HDD (hard disk drive), an optical disk, and a memory card.

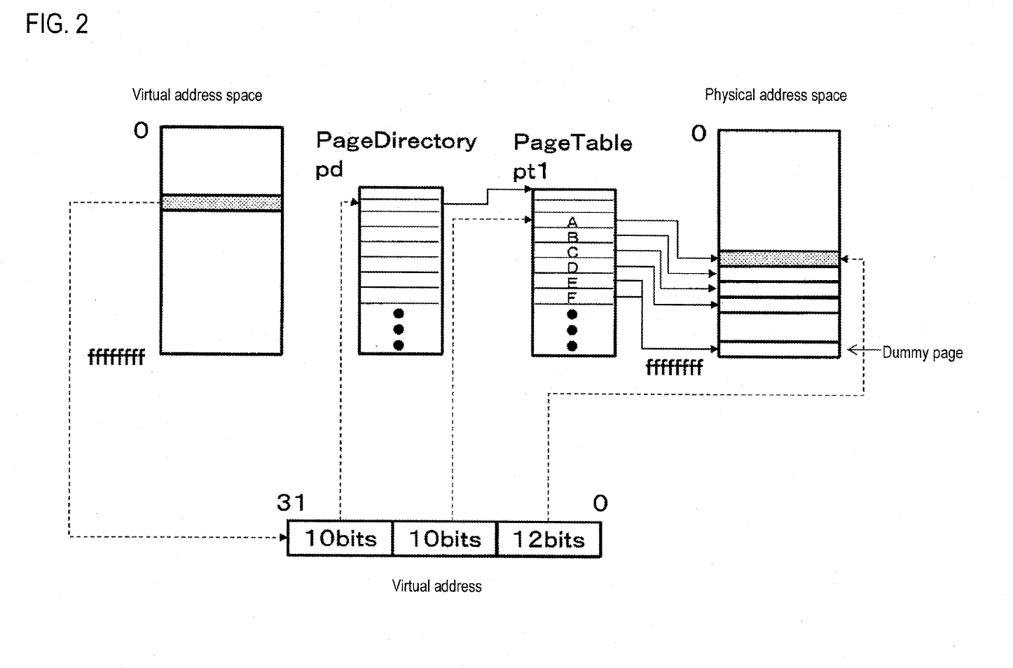

A procedure of address conversion from virtual addresses of the virtual buffer into physical addresses of the physical buffer will be described below with reference to FIG. 2.

The application 300 accesses a logically linear memory space in the virtual address space, using the virtual addresses. In this embodiment, virtual addresses having a 32-bit length are used. The virtual address is divided into portions of 10 bits, 10 bits, and 12 bits. The individual portions have the following meanings

The higher 10 bits of the virtual address are used to specify an entry in PageDirectory which is a higher-level table of conversion tables which are expressed by a 2-level layered structure. Each entry contains a pointer that specifies one of plural PageTables which are lower-level tables. FIG. 2 shows an example in which a PageTable denoted by pt1 is pointed.

The middle-level 10 bits of the virtual address are used to specify an entry in PageTable that is specified by the above pointer. Each entry contains a pointer for specifying a page block (hereinafter simply referred to as a “page”) in the physical address space. The term “page” means a minimum physical memory unit that can be mapped to virtual addresses. Continuous physical memory is allocated to a page.

The lower-level 12 bits of the virtual address indicates an offset in the page that is specified by the above pointer. For example, where one page consists of 4,096 bytes, the offset takes a value in a range of “0” to “4,095.” In the example of FIG. 2, the offset “0” specifies the top-left corner position of the hatched page in the physical address space.

A 32-bit virtual address can be converted into a physical address in the above-described manner.

In the first embodiment, the virtual buffer allocation module 401 newly allocates physical addresses to virtual addresses corresponding to the image drawing region and allocates the same dummy page to all of virtual addresses corresponding to a region outside the image drawing region. The dummy page may be shared by plural applications 300.

For example, where the screen size is 1,024×768 pixels, a data amount per pixel is 4 bytes, and one page consists of 4,096 bytes, one line in the raster (horizontal) direction corresponds to one page. Therefore, allocation of a physical buffer having a size of 1,024×4 pixels means allocation of physical addresses of four pages.

In the example shown in FIG. 2, physical addresses are newly allocated to entries A, B, C, and D of PageTable pt1 and the same dummy page is allocated to entries E and F of PageTable pt1. Where only 1,024×4 pixels of a screen having 1,024×768 pixels constitute the image drawing region, the same dummy page is allocated to information of 764 (=768−4) pages.

The window manager 200 includes an image drawing module 201.

The image drawing module 201 receives an image drawing command from the application 300. Then, the image drawing module 201 issues, for virtual addresses which are specified based on coordinate information etc. included in the image drawing command, a write request for writing image information which is an execution result of various types of image processing according to the image drawing command. In the case of a screen of, for example, 1,024×768 pixels, the coordinate information is information that is expressed in a coordinate system in which the top-left corner and the bottom-right corner are represented by (0, 0) and (1,023, 767), respectively.

The hardware 500 includes a first converter 501 and the physical buffer 502.

The first converter 501 converts virtual addresses of the virtual buffer into physical addresses of the physical buffer 502. When the image drawing module 201 acquires the physical addresses from the first converter 501, the image drawing module 201 writes image information to the physical buffer 502 at the resultant physical addresses.

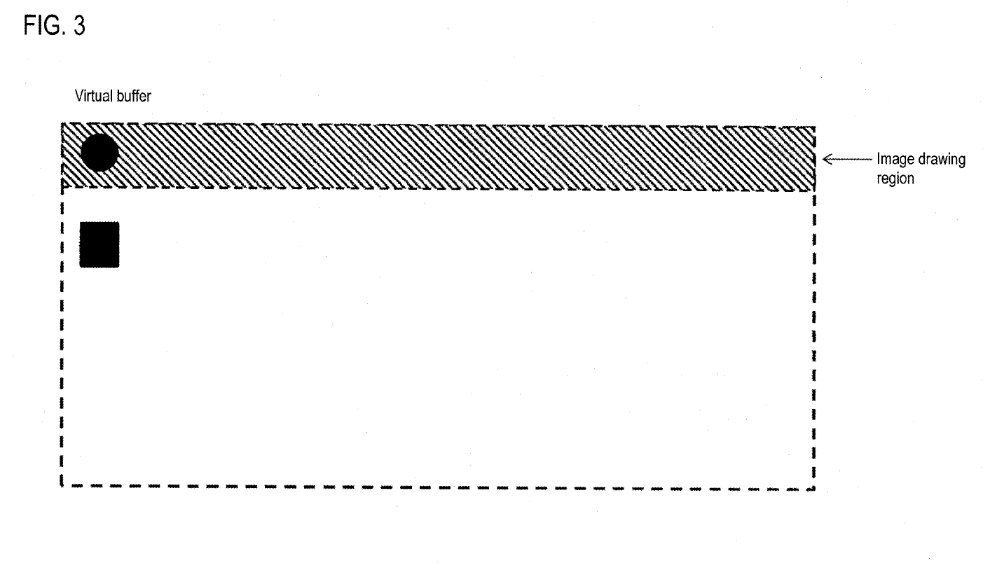

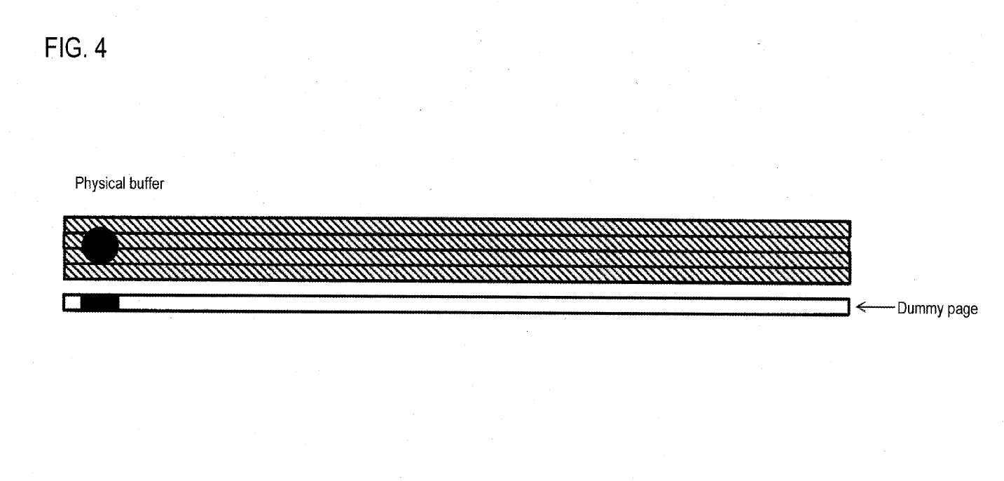

FIG. 3 shows an example of an application screen. FIG. 4 shows an example of how to draw an image in the physical buffer 502. The example of FIG. 4 corresponds to FIG. 3. As shown in FIG. 3, the image drawing region is a top region having a size of 1,024×4 pixels on the screen. Where a black circle is drawn in the image drawing region and a black rectangle is drawn outside the image drawing region, the back circle is drawn in the physical buffer 502 corresponding to the image drawing region and the black rectangle is drawn in a dummy page as shown in FIG. 4.

Next, description will be given on a buffer allocation process and image processing which are executed by the image processing apparatus 100 according to the first embodiment.

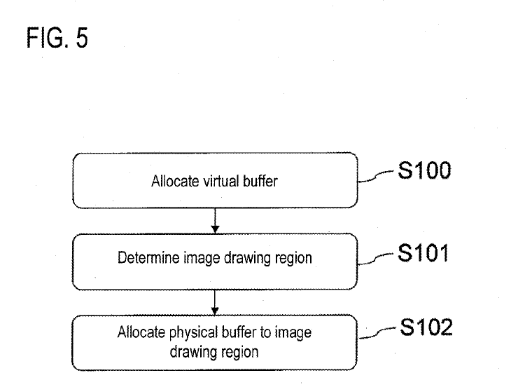

At first, an outline of the buffer allocation process will be described with reference to FIG. 5.

At step S100, the virtual buffer allocation module 402 allocates a virtual buffer according to a resolution setting of a display. For example, where the screen size is 1,024×768 pixels, virtual buffer having addresses 0x00000000 to 0x002fffff are allocated.

At step S101, the image drawing region determining module 301 determines an image drawing region.

Finally, at step S 102, the physical buffer allocation module 401 allocates the physical buffer 502 according to the size of the image drawing region. Each of entries, corresponding to the image drawing region, of PageTable contains a pointer specifying addresses of the physical buffer 502. Also, each of entries, corresponding to a region outside the image drawing region, of PageTable contains a pointer specifying a dummy page. For example, where the image drawing region is a top region having a size of 1,024×4 pixels on the screen of 1,024×768 pixels, entries corresponding to virtual addresses 0x00000000 to 0x0003fff which correspond to the image drawing region contain pointers specifying addresses of the physical buffer 502, and entries corresponding to virtual addresses 0x00004000 to 0x002ffff which correspond to a region outside the image drawing region contain pointers specifying a dummy page.

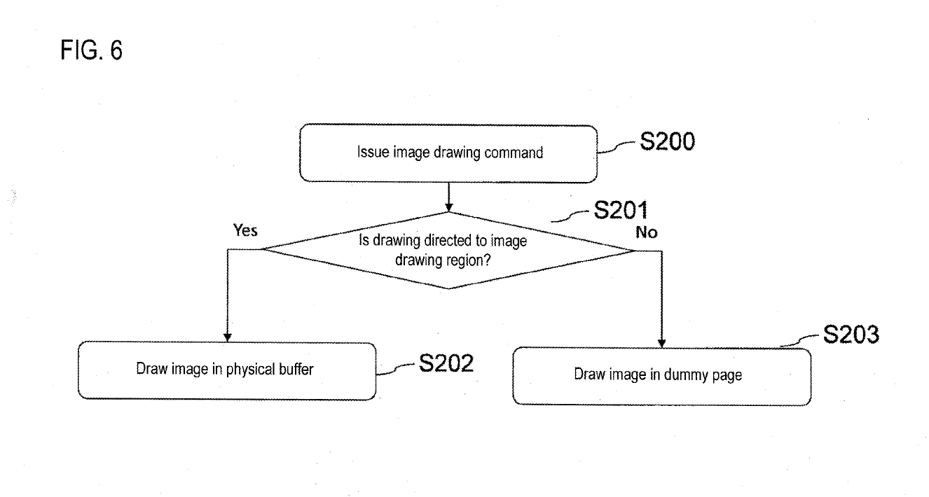

Next, an outline of the image processing will be described with reference to FIG. 6.

At first, the application 300 issues an image drawing command (step S200).

Then, the image drawing module 201 specifies virtual addresses of the virtual buffer based on coordinate information, etc. included in the image drawing command and issues an image information write request. If the image drawing command is one for drawing an image in the image drawing region, the image information write request is one for writing image information into physical addresses of the physical buffer 502. If the image drawing command is one for drawing an image outside the image drawing region, the image information write request is one for writing image information into physical addresses of the dummy page (step S201).

At step S202, the first converter 501 converts the virtual addresses of the virtual buffer into physical addresses of the physical buffer 502 and writes image information into the physical addresses of the physical buffer 502. For example, virtual addresses of a rectangle having 1,024 pixels in width and 1 pixel in height with respect to the origin (0, 0) of the screen are 0x00000000 to 0x00001fff. These virtual addresses are converted into physical addresses using PageTable. Virtual addresses for drawing of an image in the image drawing region are converted into physical addresses of the physical buffer 502, and virtual addresses for drawing of an image outside the image drawing region are converted into physical addresses of the dummy page. Then, an image is drawn accordingly.

As described above, in the image processing apparatus 100 according to the first embodiment, the physical buffer 502 is allocated only to the image drawing region, and the same dummy page is allocated to the entire region outside the image drawing region. Thereby, the memory consumption of the image processing apparatus 100 can be reduced.

### Second Embodiment

A second embodiment in which an image drawing command to draw an image outside an image drawing region is discarded will be described below.

In the first embodiment, drawing an image outside an image drawing region is performed in a dummy page.

In contrast, the second embodiment is directed to a case where an image drawing command to drawn an image outside an image drawing region is discarded without the image being drawn.

Parts common to those in the first embodiment will be give the same reference numerals, and descriptions thereon will be omitted appropriately.

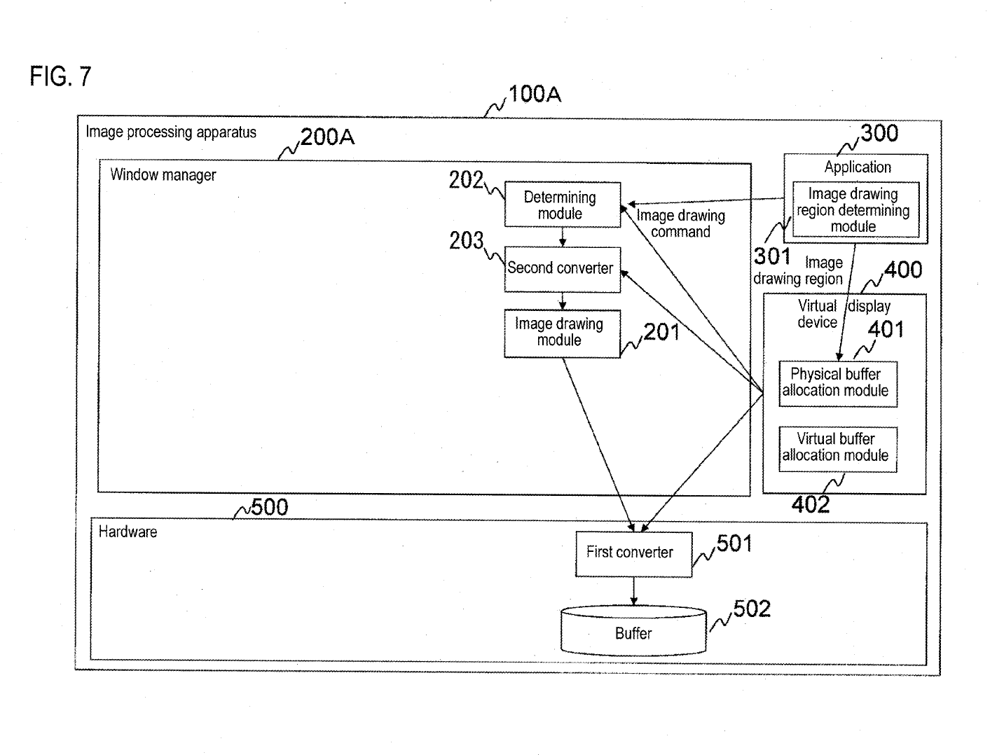

FIG. 7 shows an example configuration of an image processing apparatus 100A according to a second embodiment.

The second embodiment is different from the first embodiment in that a determining module 202 and a second converter 203 are added. Other configuration of the image processing apparatus 100A according to the second embodiment is similar to that of the image processing apparatus 100 according to the first embodiment, and description thereon will be omitted.

In the first embodiment, the virtual buffer allocation module 402 allocates effective virtual addresses which are set in PageTable. In the second embodiment, the virtual buffer allocation module 402 allocates dummy virtual addresses. For example, in the case of a screen of 1,024×768 pixels, the virtual buffer allocation module 402 allocates dummy virtual addresses 0x00000000 to 0x002fffff. The dummy virtual addresses are notified to the application 300.

The physical buffer allocation module 401 allocates effective virtual addresses and physical addresses which correspond to an image drawing region. For example, where an image drawing region is a region having 64 pixels in width and 64 pixels in height with respect to the origin (0, 0) of the screen, the physical buffer allocation module 401 allocates physical addresses corresponding to 64×64 pixels (for example, 0x00300000 to 0x00300ffc). The physical buffer allocation module 401 also allocates effective virtual addresses (for example, 0x00400000 to 0x00400ffc).

The determining module 202 receives an image drawing command from the application 300 and determines as to whether or not the received image drawing command is directed to the image drawing region. If the image drawing command corresponds to the image drawing region, the determining module 202 passes the image drawing command to the second converter 203. If not, the determining module 202 discards the image drawing command. For example, if an image drawing command for drawing a rectangle having 1,024 pixels in width and 100 pixels in height with respect to a position (100, 0) of the screen is issued in the case where the image drawing region has 64 pixels in width and 64 pixels in height with respect to the origin (0, 0) of the screen, the image drawing command is discarded.

If the received image drawing command is directed to both of the image drawing region and a region outside the image drawing region (the received image drawings command straddles the image drawing region and a region outside the image drawing region), the second converter 203 converts the image drawing command so that the resultant image drawing command will cause image drawing only in the image drawing region. For example, if an image drawing command for drawing a rectangle having 1,024 pixels in width and 100 pixels in height with respect to the origin (0, 0) is issued in the case where the image drawing region has 64 pixels in width and 64 pixels in height with respect to the origin (0, 0) of the screen, the second converter 203 converts the image drawing command into an image drawing command for drawing a rectangle having 64 pixels in width and 64 pixels in height with respect to the origin (0, 0). Also, the second converter 203 converts dummy virtual addresses into effective virtual addresses.

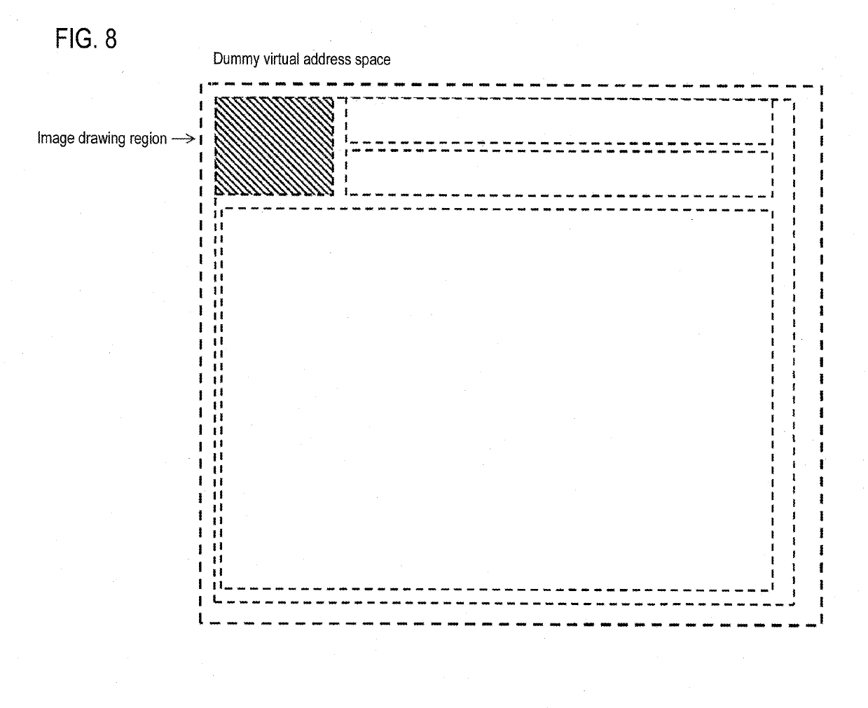

FIG. 8 shows an example of an application screen. A dummy virtual address space is used for a layout calculation. For example, when the application 300 is drawn in a virtual buffer with a position (10, 10) used as a reference point, an image drawing command for drawing a rectangle having 64 pixels in width and 64 pixels in height with respect to the origin (0, 0) of the application screen is issued as an image drawing command for drawing a rectangle having 64 pixels in width and 64 pixels in height with respect to the position (10, 10) in the virtual buffer. A window manager 200A manages window information including information such as a window drawing position with respect to the application screen and a window size.

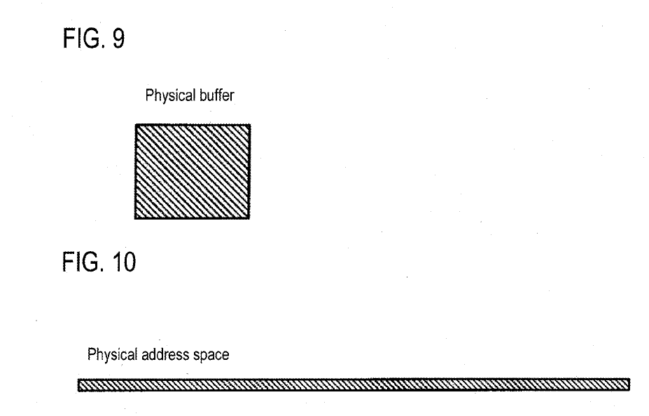

FIGS. 9 and 10, which correspond to FIG. 8, show an example of how to draw an image in the physical buffer 502 and a physical address space, respectively. Continuous physical addresses are allocated to the physical addresses. For example, as shown in FIG. 10, continuous physical addresses of one page are allocated to the physical buffer 502 having a size of 64×64 pixels.

An outline of an address conversion process and an image drawing process will be described below.

An address is calculated according to the following formula:

y×bufW×Bpp+x×Bpp+(start address)

where x and y denote position information in buffer, bufW denotes a horizontal width of the buffer in units of in the number of pixels, and Bpp denotes the number of bytes per pixel.

For example, it is assumed that dummy virtual addresses 0x00000000 to 0x002fffff are allocated to a virtual buffer having a size of 1,024×768 pixels and physical addresses 0x00300000 to 0x00300ffc and effective virtual addresses 0x00400000 to 0x00400ffc are allocated to an image drawing region having 64 pixels in width and 64 pixels in height with respect to the origin (0, 0) of an application screen. It is also assumed that the application 300 is drawn in the virtual buffer in a position (10, 10).

In this case, an image drawing command for drawing a rectangle having 64 pixels in width and 64 pixels in height with respect to the origin (0, 0) of the application screen is issued as an image drawing command for drawing a rectangle having 64 pixels in width and 64 pixels in height with respect to the position (10, 10) in the virtual buffer. The image drawing module 201 issues a write request for each horizontal width. Therefore, at first, a write request is issued for a line of 64 pixels starting from the position (10, 10). Then, the second converter 203 obtains a dummy virtual address “0x00009028” corresponding to the position (10, 10) by substituting x=10, y=10, bufW=1,024, and (start address)=0x00000000 into the above formula. Since the physical buffer 502 includes only the image drawing region, the second converter 203 then obtains an effective virtual address “0x00400000” by substituting x=0, y=0, bufW=64, and (start address)=0x00400000 into the above formula. The dummy virtual address is thus converted into the effective virtual address.

Here, x=0 and y=0 which are substituted into the formula may be obtained based on (i) the image drawing command (indicating at least the drawing position (10, 10) in the virtual buffer) and (ii) the window information (indicating at least the drawing position of the window corresponding to the application 300) managed by the window manager 200A.

Then, the first converter 501 obtains a physical address “0x00300000” by substituting x=0, y=0, bufW=64, and (start address)=0x00300000 into the above formula. The effective virtual address is thus converted into the physical address. Image information generated by the image drawing module 201 and having 64 pixels in width and 1 pixel in height is written into physical addresses starting from the obtained physical address (0x00300000).

Subsequently, a write request is issued for a line of 64 pixels starting from the position (10, 11). Then, the second converter 203 obtains a dummy virtual address “0x0000a028” corresponding to the position (10, 11) by substituting x=10, y=11, bufW=1,024, and (start address)=0x00000000 into the above formula. The second converter 203 then obtains an effective virtual address “0x00400100” by substituting x=0, y=1, bufW=64, and (start address)=0x00400000 into the above formula. The first converter 501 obtains a physical address “0x00300100” by substituting x=0, y=1, bufW=64, and (start address)=0x00300000 into the above formula. In this manner, the image drawing process is performed in parallel with the address conversion process.

The image drawing region may be changed during the operation. In this case, the conversion process from dummy virtual addresses into effective virtual addresses is changed according to the change of the image drawing region. Also, a physical address need not always be allocated for each application; a common physical buffer may be allocated and images may be drawn in such a manner that image drawing regions for plural applications are arranged adjacent to each other.

Next, description will be made on a buffer allocation process and image processing which are performed by the above-configured image processing apparatus 100A according to the second embodiment.

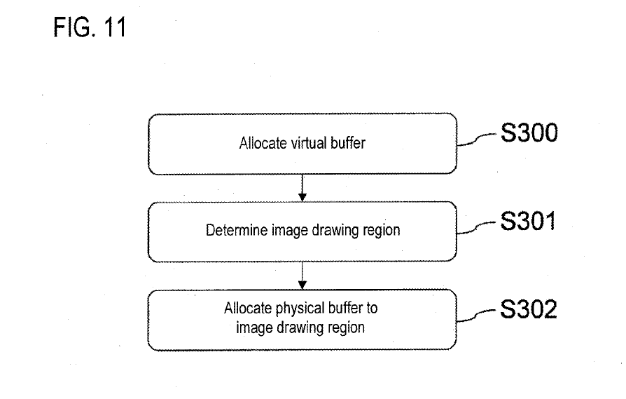

At first, an outline of the buffer allocation process will be described with reference to FIG. 11. In this regard, the second embodiment is different in the functions of the virtual buffer allocation module 402 and the physical buffer allocation module 401 from the first embodiment. The other functions are similar to those of those of the virtual buffer allocation module 402 and the physical buffer allocation module 401 according to the first embodiment, and thus description thereon will be omitted.

In the first embodiment, the virtual buffer allocation module 402 allocates effective virtual addresses.

In the second embodiment, at step S300, the virtual buffer allocation module 402 allocates dummy virtual addresses.

In the first embodiment, the physical buffer allocation module 401 generates entries of PageTable corresponding to a virtual buffer and allocates a dummy page to a region outside an image drawing region.

In the second embodiment, the physical buffer allocation module 401 generates only entries of PageTable corresponding to a physical buffer 502. At step S301, the image drawing region determining module 301 determines an image drawing region. At step S302, the physical buffer 502 is allocated to the determined image drawing region, and nothing is allocated to a region outside the image drawing region.

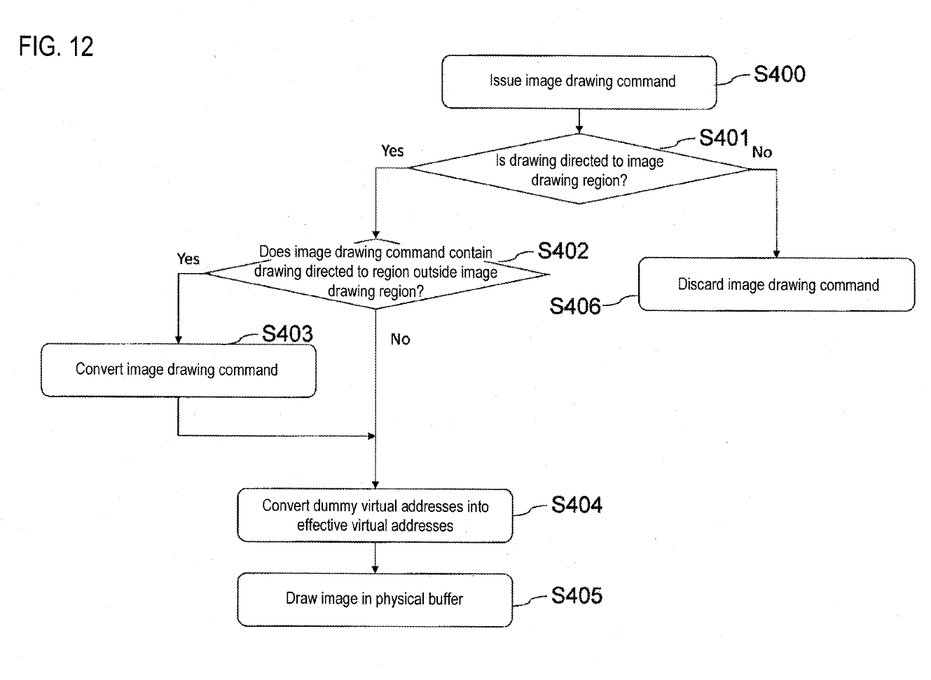

Next, an outline of the image processing will be described with reference to FIG. 12. In this connection, the second embodiment is different from the first embodiment in that the determining module 202 and the second converter 203 are added. The other functions are similar to the window manager 200 according to the first embodiment, and thus description thereon will be omitted.

At first, at step S400, the determining module 202 receives an image drawing command from the application 300. At step S401, the determining module 202 determines as to whether or not the image drawing command is directed to the image drawing region. If the image drawing command is directed to the image drawing region, the determining module 202 passes the image drawing command to the second converter 203. If not, at step S406 the determining module 202 discards the image drawing command.

If the image drawing command is directed to both of the image drawing region and a region outside the image drawing region (Yes at S402), at step S403 the second converter 203 converts the image drawing command so as to cause image drawing only in the image drawing region. The second converter 203 converts dummy virtual addresses into effective virtual addresses at step S404, and writes image information corresponding to the image drawing region into the physical buffer 502 at step S405.

As described above, in the image processing apparatus 100A according to the second embodiment, no physical addresses are allocated to a region outside an image drawing region, and an image drawing command directed to such an outside area is discarded without causing image drawing. Thereby, the memory consumption of the image processing apparatus 100A can be reduced.

### Third Embodiment

A third embodiment will be described below in which image information in an image drawing region is transmitted to a client (display device). Modules which are the same as those of the first embodiment will be give the same reference symbols and description thereon will be omitted where appropriate.

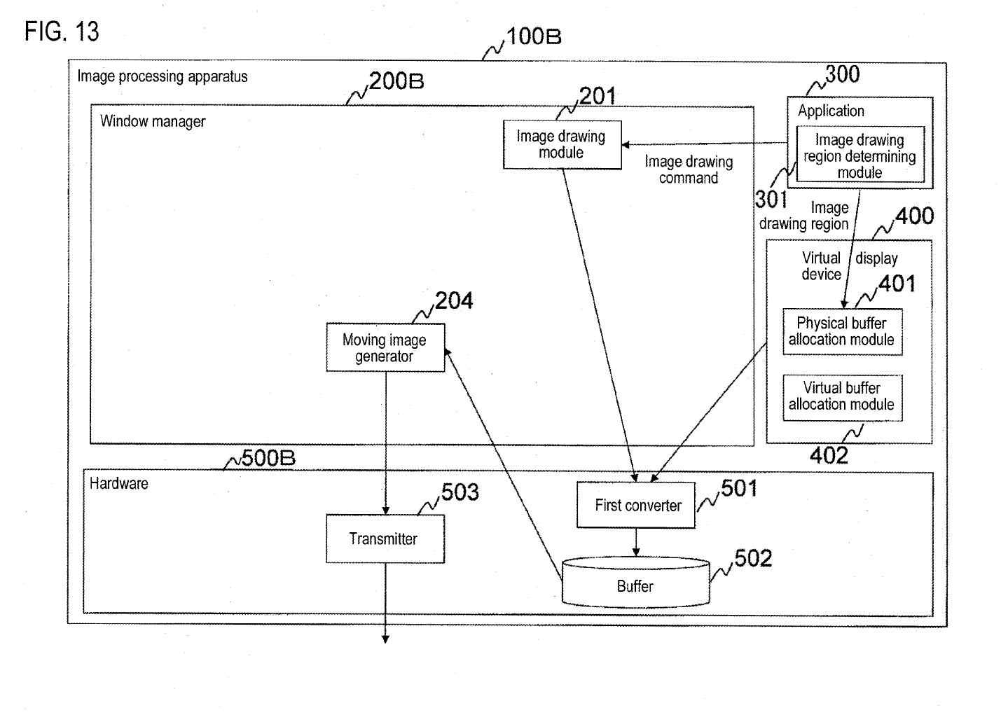

FIG. 13 shows an example configuration of an image processing apparatus 100B according to the third embodiment.

The third embodiment is different from the first embodiment in that a moving image generator 204 and a transmitter 503 are added.

The moving image generator 204 acquires image information in an image drawing region from a physical buffer 502 and generates a moving image

The generated moving image may be of any type such as the H.264 type. The moving image generator 204 may generate only an updated image. For example, the moving image generator 204 may generate a JPEG image by acquiring image drawing information from the image drawing module 201 and acquiring image information only in a region where a new image drawing event has occurred. For another example, the moving image generator 204 may generate a PNG image by comparing an image in a physical buffer 502 and a backup image that has been transmitted to the client and acquiring image information only in a difference region (i.e., a region where actual variations have occurred).

The transmitter 503 transmits the moving image generated by the moving image generator 204 to the client.

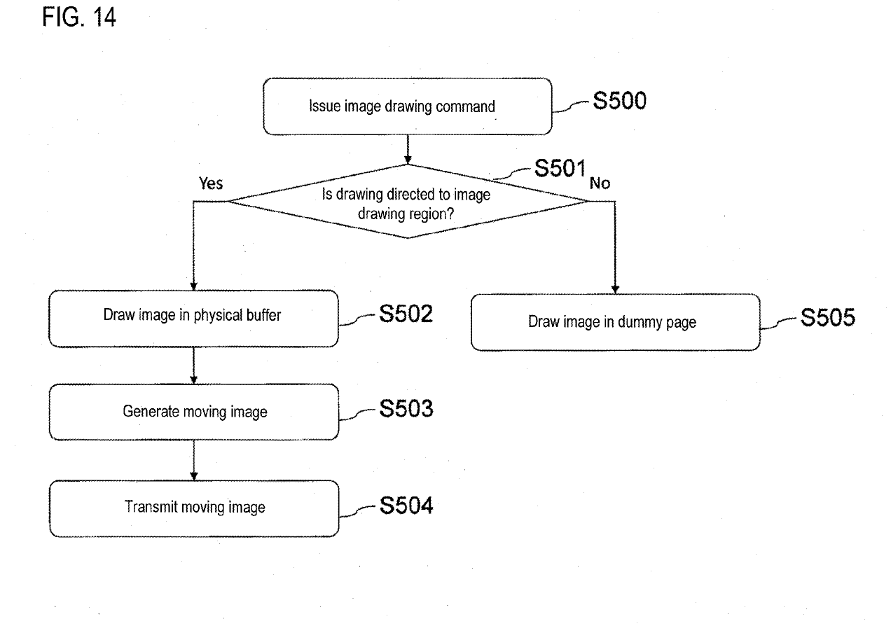

Next, an outline of image processing will be outlined with reference to FIG. 14. The third embodiment is different from the first embodiment in that the moving image generator 204 and the transmitter 503 are added. The other functions are similar to those of the image processing apparatus 100 according to the first embodiment. Steps S500 to S502 and S505 correspond to steps S200 to S203 of the first embodiment, respectively, and thus description thereon will be omitted.

At step S503, the moving image generator 204 acquires image information in an image drawing region from the physical buffer 502 and generates a moving image.

Then, at step S504, the transmitter 503 transmits the moving image to the client.

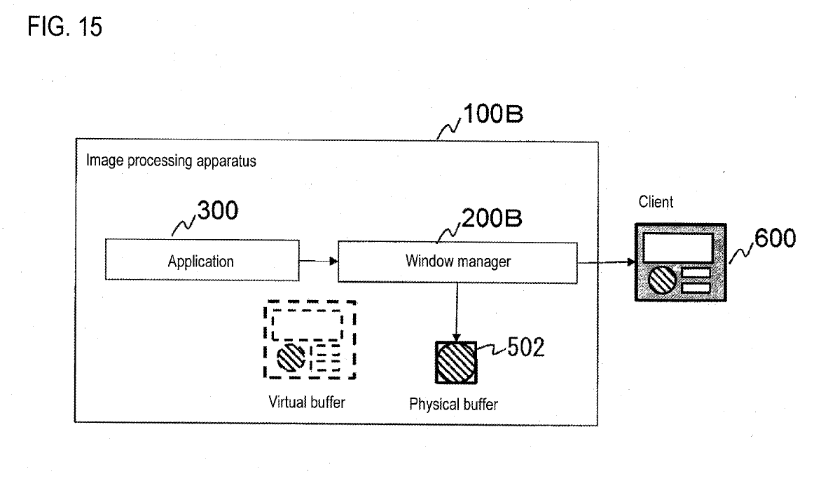

FIG. 15 illustrates an example procedure of moving image transmission process. In the example of FIG. 15, a client 600 receives image information drawn by the image processing apparatus 100B as a moving image or an image, displays the received moving image or received image in a bottom left portion of the screen of the client 600, and draws an image in the other portion of the screen. The client 600 combines and displays these images.

The client 600 includes a receiver (not shown) configured to receive the image information from the image processing apparatus 100B over a network, and a display device (not shown) configured to display the image information received by the receiver.

As seen from the above description, the image processing apparatus 100B according to the third embodiment can be applied to a distributed process system in which the image processing apparatus and the client take charge of respective parts of the image drawing process.

According to another embodiment, an image processing apparatus includes a memory and a controller. The memory is configured store computer instructions. The controller is coupled to the memory. Execution of the computer instructions by the controller causes the controller to perform operations. The operations include: determining an image drawing region based on first image information; allocating virtual addresses to a virtual buffer configured to store the first image information virtually; allocating physical addresses to a physical buffer configured to store second image information corresponding to the image drawing region; converting at least a part of the virtual addresses allocated to the virtual buffer into at least a part of the physical addresses allocated to the physical buffer, the at least part of the virtual addresses corresponding to the second image information; and storing the second image information in the physical buffer based on the physical addresses obtained through the converting. The controller may be a processor such as a CPU. The memory may be any of RAM (random access memory), an HDD (hard disk drive), an optical disk, and a memory card.

Specifically, the image processing apparatus 100, 100A, 100B may include the controller and the memory. Any of the window manager 200, 200A, 200B, the application 300, the virtual display device 400, 400A, the hardware 500, 500A, 500B may be implemented by a general purpose computer (including a controller and a memory) and a program(s) run on the general purpose computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
an image drawing region determining module configured to determine an image drawing region based on first image information;
a virtual buffer allocation module configured to allocate virtual addresses to a virtual buffer configured to store the first image information virtually;
a physical buffer allocation module configured to allocate physical addresses to a physical buffer configured to store second image information corresponding to the image drawing region determined by the image drawing region determining module;
a first converter configured to convert at least a part of the virtual addresses allocated to the virtual buffer into at least a part of the physical addresses allocated to the physical buffer, the at least part of the virtual addresses corresponding to the second image information; and
an image drawing module configured to store the second image information in the physical buffer based on the physical addresses obtained through the conversion by the first converter.

2. The apparatus of claim 1, wherein
the physical buffer allocation module is configured to allocate the physical buffer physical addresses corresponding to third image information that corresponds to a region outside the image drawing region determined by the image drawing region determining module, and
the image drawing module is configured to store the third image information in a dummy page of the physical buffer according to the allocated physical addresses corresponding to the third image information.

3. The apparatus of claim 2, wherein the image drawing module is configured to store all of the third image information in the same dummy page.

4. The apparatus of claim 1, further comprising:
a determining module configured to determine as to whether or not an image drawing command received from an application is an image drawing command corresponding to the image drawing region; and
a second converter configured to convert the image drawing command so that a resultant image drawing command will cause image drawing only in the image drawing region if the image drawing command is directed to both of the image drawing region and a region outside the image drawing region, wherein
the image drawing module is configured to store the second image information in the physical buffer according to instructions from the first converter and the second converter.

5. The apparatus of claim 4, wherein the determining module is configured to notify the received image drawing command to the second converter if the received image drawing command is directed to the image drawing region.

6. The apparatus of claim 4, wherein the determining module is configured to discard the received image drawing command if the received image drawing command is not directed to the image drawing region.

7. The apparatus of claim 1, further comprising:
a moving image generator configured to acquire the second image information from the physical buffer and generate a moving image; and
a transmitter configured to transmit the moving image generated by the moving image generator.

8. A computer readable storage medium storing a program that causes a computer to execute image processing, the image processing comprising:
determining an image drawing region based on first image information;
allocating virtual addresses to a virtual buffer configured to store the first image information virtually;
allocating physical addresses to a physical buffer configured to store second image information corresponding to the image drawing region;
converting at least a part of the virtual addresses allocated to the virtual buffer into at least a part of the physical addresses allocated to the physical buffer, the at least part of the virtual addresses corresponding to the second image information; and
storing the second image information in the physical buffer based on the physical addresses obtained through the converting.

9. An image processing system comprising:
an image processing apparatus; and
a client apparatus that is connected to the image processing apparatus via a network, wherein
the image processing apparatus comprises
an image drawing region determining module configured to determine an image drawing region based on first image information,
a virtual buffer allocation module configured to allocate virtual addresses to a virtual buffer configured to store the first image information virtually,
a physical buffer allocation module configured to allocate physical addresses to a physical buffer configured to store second image information corresponding to the image drawing region determined by the image drawing region determining module,
a first converter configured to convert at least a part of the virtual addresses allocated to the virtual buffer into at least a part of the physical addresses allocated to the physical buffer, the at least part of the virtual addresses corresponding to the second image information, and
an image drawing module configured to store the second image information in the physical buffer based on the physical addresses obtained through the conversion by the first converter, and
a transmitter configured to transmit the second image information acquired from the physical buffer to an outside of the image processing apparatus; and
the client apparatus comprises
a receiver configured to receive the second image information from the image processing apparatus over the network, and
the display device configured to display the second image information received by the receiver.
